(19) United States
(12) Patent Application Publication
(10) Pub. No.: US 2023/0209206 A1
(43) Pub. Date: Jun. 29, 2023

(54) VEHICLE CAMERA DYNAMICS

(71) Applicant: Rivian IP Holdings, LLC, Irvine, CA (US)

(72) Inventor: Kiran Ram Bharwani, San Ramon, CA (US)

(21) Appl. No.: 17/564,055

(22) Filed: Dec. 28, 2021

(51) Int. Cl. H04N 5/235; B60W 40/02; G06V 20/56

(52) U.S. Cl. CPC H04N 5/2353; B60W 40/02; G06V 20/56; B60W 2420/42; G06T 2207/30252

(57) ABSTRACT

A system for a vehicle may include a camera configured to collect image data. The camera may have an adjustable exposure. The system may also include a controller in communication with the camera. The controller may be configured to adjust the camera exposure in a constant ambient light environment based upon an anticipated change in ambient light determined from a location of the camera.

### INTRODUCTION

The present disclosure is directed a vehicle, and more particularly towards a vehicle with a vision system that employs a camera.

### SUMMARY

In at least some example illustrations, a vehicle system includes a camera configured to collect image data. The vehicle system also includes a controller in communication with the camera. The controller is configured to determine an anticipated change in ambient light based on a location of the camera and a moving direction of the vehicle. The controller is also configured to adjust an exposure of the camera based on the anticipated change in ambient light.

In some of the above examples, the camera is a forward-facing camera of the vehicle. In a subset of these embodiments, an additional forward-facing camera of the vehicle is also included as part of an autonomous driving system, and a camera exposure of the additional forward-facing camera is not adjusted based on the anticipated change in ambient light. Further, the controller is configured to determine a presence of an object in front of the vehicle when either of the forward-facing cameras detect the object.

In some of the above examples of a vehicle system, the controller is configured to adjust the camera exposure in response to a detection of the vehicle approaching an ambient light transition location.

In some of the above examples of a vehicle system, the controller is in communication with a memory comprising a plurality of ambient light transition locations.

Some examples of a vehicle system may also include a location sensor in communication with the controller, with the location sensor being configured to determine the location of the camera.

In some of the above examples of a vehicle system, the controller is configured to determine the location of the camera from one of a global positioning satellite (GPS) sensor or a global navigation satellite system (GNSS) sensor.

In some example vehicle systems, the controller is configured to determine the location of the camera based upon a vehicle speed.

In another example illustration, an autonomous driving system for a vehicle includes a forward-facing camera configured to collect image data for autonomous vehicle guidance. The autonomous driving system may also include a controller in communication with the camera, with the controller configured to determine an anticipated change in ambient light based on a detection of the vehicle approaching an ambient light transition location. The controller is configured to adjust an exposure of the camera based on the anticipated change in ambient light. The autonomous driving system may also include an additional forward-facing camera of the vehicle, and the controller may be configured to adjust exposure of the additional forward-facing camera in response to changes in ambient light received at the additional forward-facing camera. In this example, the controller may be configured to determine a presence of an object in front of the vehicle when either of the forward-facing cameras detect the object.

In some example autonomous driving systems, the controller is in communication with a memory comprising a plurality of ambient light transition locations.

In at least some example illustrations, a method of adjusting a camera setting includes determining an anticipated change in ambient light based on a location of a camera and a moving direction of a vehicle. The method further includes adjusting an exposure of the camera based on the anticipated change in the ambient light.

In at least some of these example methods, the camera is a forward-facing camera of a vehicle. In a subset of these examples, a method may also include receiving additional image data from an additional forward-facing camera of the vehicle and adjusting exposure of the additional forward-facing camera in response to changes in ambient light received at the additional forward-facing camera. In a further subset of these examples, a method may also include determining a presence of an object in front of the vehicle when either of the forward-facing cameras detect the object.

At least some example methods may also include adjusting the camera exposure in response to a detection of the vehicle approaching an ambient light transition location.

Some example methods may also include storing a plurality of ambient light transition locations in a memory installed in the vehicle.

In some example methods, the location of the camera is determined by a location sensor. In a subset of these example methods, the location sensor includes one of a global positioning satellite (GPS) sensor or a global navigation satellite system (GNSS) sensor.

At least some example methods also include determining the location of the camera based upon a vehicle speed.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows a schematic view of an illustrative vehicle having an image data collection system, in accordance with some embodiments of the present disclosure;

FIG. 2 shows a schematic view of the vehicle of FIG. 1 with respective image data sets, in accordance with some embodiments of the present disclosure;

FIG. 3 shows a schematic view of an illustrative vehicle and locations of ambient lighting transitions, in accordance with some embodiments of the present disclosure;

FIG. 4 shows a schematic view of an illustrative vehicle having an image data collection system, in accordance with some embodiments of the present disclosure;

FIG. 5 shows a flowchart of an illustrative process of adjusting a camera setting, in accordance with some embodiments of the present disclosure; and

FIG. 6 shows a flowchart of another illustrative process for adjusting a camera setting, in accordance with some embodiments of the present disclosure.

### DETAILED DESCRIPTION

Vehicles may rely upon cameras for determining surroundings of a vehicle, e.g., as part of an autonomous or semi-autonomous driving system or active safety features. Typically, cameras employ an automatic exposure (AE) adjustment that responds to changes in ambient lighting conditions around the vehicle by adjusting one or more settings of the camera. For example, as ambient light decreases, an aperture, shutter speed, or other setting may be adjusted to allow the camera to accurately capture image and/or video data of surroundings of the vehicle despite the changed ambient lighting. More specifically, cameras may employ automatic exposure algorithms in an image signal processor (ISP) to analyze brightness information from a sensor. The ISP may determine appropriate values for aperture, shutter speed and ISO sensitivity.

Real world driving situations for a vehicle often have high dynamic range (HDR) environments where ambient lighting changes rapidly, for example when entering or exiting a tunnel. Even where processing capability of an ISP is robust, automatic exposure adjustment algorithms often cannot change rapidly enough to avoid reduced visibility or temporary over/under-exposure due to the quick changes in illumination or ambient lighting.

Accordingly, example approaches herein generally employ a camera having one or more settings that may be adjusted to change an exposure of the camera or collected image or video data to ambient light. Further, changes in ambient lighting may be anticipated such that one or more of the exposure settings are changed before an expected change in ambient light occurs. In some example approaches, locations of transitions in ambient light may be used, along with location data of the vehicle and/or camera, to determine potential changes in ambient lighting. By changing exposure setting(s) of the camera advance of an expected transition in ambient light, the camera may be prevented from temporary over-exposure or under-exposure when the ambient light transition occurs.

As used herein, exposure settings may generally relate to a sensitivity of the camera to ambient lighting. Merely as examples, one or more of an aperture setting, a shutter speed setting, an ISO setting, or any other setting affecting a camera's sensitivity to ambient lighting may be altered in example approaches. As will be described further below, to the extent the changing exposure setting(s) in advance of a change in ambient lighting affects camera performance in the camera's present ambient lighting/environment, additional image data may be collected using currently-appropriate exposure settings may be collected, e.g., via an additional camera. Vehicle systems, such as autonomous or semi-autonomous driving systems, may thereby have robust image data of vehicle surroundings that is less dependent upon a camera or imaging system's ability to change exposure settings as ambient lighting changes.

In some example approaches, a database of ambient light change locations, e.g., tunnels, bridges, forests, or the like, may be provided to a vehicle. In one such example, a High-Definition map (e.g., “HD Maps”) is employed. In these examples, a map or database provides information on where ambient lighting changes occur, such as where tunnels start and end. This information can be used to adjust camera dynamics to avoid temporary over-exposure or under-exposure, such as a tunnel blindness effect. In some examples a gain control system of the camera can be adjusted by predicting these lighting changes, i.e., when a vehicle is entering/exiting a tunnel. In example illustrations, position information such as that provided by Global Positioning Satellite (GPS) and/or Global Navigation Satellite System (GNSS) data may be provided along with data from HD Maps to a vehicle. In one example approach, both GPS and HD Maps are used to determine an accurate location of the vehicle, e.g., relative to a start/end of a tunnel. Based on the known position of the vehicle and location of ambient light changes via HD Maps, example systems can accurately predict when the vehicle will be entering/exiting the tunnel, for example. Example systems may thereby adapt camera dynamics in advance of these entry/exit events.

Various levels of autonomous operation or driver warning systems may employ example systems and methods for adjusting exposure settings, which may generally be directed to obtaining image data from a front of the vehicle, e.g., as part of a highway driving assist feature of the vehicle configured to look further down the road for the vehicle.

In some examples, location data such as GPS or GNSS may not be available. For example, a tunnel or bridge may prevent contact with GPS/GNSS system components. Additionally, location data may not be consistently available in remote areas. Example systems herein may, in response to unavailability of location data, employ dead reckoning and/or determine a location of the vehicle using an inertial measurement unit (IMU), wheel speeds, or other known vehicle data, along with a last-known location from relevant location data systems such as GPS/GNSS. Accordingly, example systems may accurately track a vehicle's location in a map/location database despite temporary unavailability of location data.

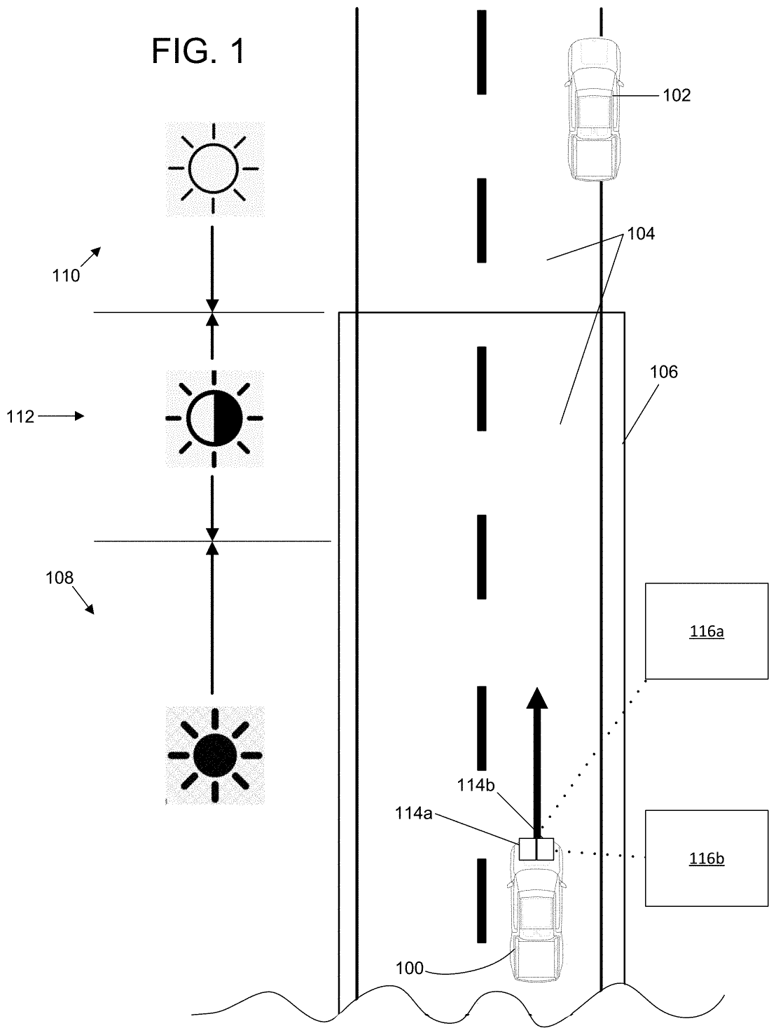

Turning now to FIG. 1, an example vehicle 100 is illustrated. The vehicle 100 is travelling through an environment with changing ambient light levels. In the example illustrated, the vehicle 100 is travelling on a road surface 104 that extends through a tunnel 106. The tunnel 106 includes a relatively darkened region 108, e.g., due to a lack of interior lighting within the tunnel 106 and limited levels of external light or sunshine that are present in the darkened region 108. A relatively light region 110 is outside the tunnel 106. Ambient light in an intermediate region 112 increases from the darkened region 108 to the light region 110. Accordingly, as the vehicle 100 travels along the road surface 104 within the tunnel, ambient lighting at the vehicle 100 is initially very limited, i.e., in the darkened region 108, and then increases as the vehicle reaches the intermediate region 112 and continues travelling toward the light region 110. To the extent the vehicle 100 may be travelling quickly, e.g., at highway speeds, or the intermediate region 112 is relatively short, ambient lighting experienced at the vehicle 100 may increase very quickly.

The vehicle 100 includes one or more cameras 114, which may be used to collect image and/or video data for the vehicle 100. In the illustrated example, the vehicle 100 includes two cameras 114a and 114b (collectively, 114) which collect image data in front of the vehicle 100. The cameras 114 are illustrated along a front end of the vehicle 100, but may be mounted inside or outside the vehicle 100 in any generally forward-facing configuration that is convenient, e.g., inside the vehicle cabin along the windshield or as part of an inside rearview mirror assembly, as part of a front grille or front bumper of the vehicle 100, etc. In some example approaches, camera(s) 114 may be used to collect image data that is used by the vehicle in a semi-autonomous or fully autonomous driving mode, or to detect objects in a path of the vehicle 100, obstructions, or pedestrians. As used herein, a semi-autonomous or fully autonomous driving mode of the vehicle 100 may be defined as a mode where the vehicle 100 controls speed and/or steering of the vehicle 100 with fully autonomous driving modes allowing the vehicle 100 to fully control steering and speed of the vehicle without intervention by a driver. The cameras 114 may collect image/video data that is used to identify objects such as vehicles, obstacles, road surfaces, or the like. While only two forward-facing cameras 114a and 114b are illustrated for purposes of the illustration in FIG. 1, it should be understood that additional cameras may be provided, e.g., which are positioned on the vehicle 100 to collect image/video data from other areas, e.g., behind vehicle 100, to the side of the vehicle 100, etc.

Camera(s) 114 may have an adjustable exposure or sensitivity to ambient lighting, such that the camera 114 may collect image data in both relatively high ambient lighting conditions, e.g., light region 110, as relatively low ambient lighting conditions, e.g., dark region 108. In the illustrated example in FIG. 1, the camera 114a and/or an associated controller (not shown in FIG. 1) may adjust one or more exposure settings in response to detected changes in ambient lighting. Exposure settings that may be adjusted may include, merely as examples, an aperture opening of a camera, shutter speed, ISO, white balance, image cropping (e.g., to generally focus the camera(s) further down the road), a color/black-and-white mode switch, or application of a filtering effect such as a U/V filter. In at least some example approaches, a reduced shutter speed and an increased ISO setting may generally be used to increase a camera exposure or brighten an image, while an increased shutter speed and reduced ISO setting may generally be used to darken an image or decrease an exposure. It should be noted that specific camera settings adjusted may be dependent upon the camera and the application, and thus the specific setting(s) adjusted may vary.

Furthermore, as will be described further below the camera 114a may be configured to predict changes in ambient lighting and change exposure setting(s) in advance of the predicted/expected change in ambient lighting. The camera 114a and/or a controller thereof may be configured to adjust an exposure of the camera 114a based upon an anticipated change in ambient light determined from a location of the camera 114a and a moving direction of the vehicle 100. In this example approach, the location of the camera may include a geographic location or relationship of the camera to a location of an anticipated change in ambient light. The moving direction of the vehicle, i.e., toward a location where ambient light is expected to change, may be used in combination with the location of the camera relative to the location where ambient light is expected to change. For example, the camera 114a, vehicle 100, or associated controller(s) may determine that the vehicle 100 is in the tunnel 106 and is approaching a location where ambient lighting is known to change. In some examples, vehicle speed may be used, alternatively or in addition to moving direction of the vehicle. For example, vehicle speed may be used to establish an expected timing for the vehicle 100 to reach a location where ambient light is expected to change, and thereby may establish timing for initiating a change in a camera setting. Based upon the predicted/expected change in ambient lighting, the camera 114a and/or an associated controller may adjust exposure setting(s) of the camera 114a before the expected change in ambient lighting occurs based on the detected location of the camera 114a and moving direction of the vehicle 100. As a result, when the predicted change in ambient lighting occurs, e.g., due to the vehicle 100 nearing the end of the tunnel 106 and/or exiting the tunnel 106, the camera 114a may already have one or more exposure settings adjusted for the increased ambient light.

The second camera 114b may also adjust exposure settings or sensitivity to ambient light, but in the example illustrated may adjust exposure setting(s) based upon current/real-time ambient light levels. Accordingly, to the extent adjusting exposure setting(s) in advance of an expected/predicted change in ambient lighting may negatively affect image data collected at the current location, the second camera 114b may be employed to maintain robust image data. A controller of the vehicle 100 may use both image data sets 116a and 116b, e.g., by detecting objects such as vehicle 102 whenever either image data set 116 is indicative of the presence of the vehicle 102. In another example, a controller or processing circuitry may alternate usage of the image data sets 116a and 116b based upon ambient lighting conditions of the vehicle. For example, as the vehicle 100 reaches a predicted ambient light transition location, the vehicle may switch from image data 116b provided by the camera 114b (which may not, at the moment the vehicle reaches the ambient light transition, have yet adjusted exposure settings due to detected ambient light) to image data 116a provided by camera 114a.

Each of the cameras 114a and 114b may collect different sets of image data 116a and 116b, respectively, reflecting the different strategies for adjusting exposure setting(s) of the cameras 114a, and 114b. The vehicle 100 may use each of the image data sets 116 to determine the presence, size, positioning, and/or distance to objects in the path of the vehicle 100, e.g., a stopped vehicle 102, as will be discussed further below.

In some example approaches, the vehicle 100 may determine a presence of an object such as the vehicle 102 in response to a detection by either of the cameras 114a/114b and their associated image data 116a/116b, respectively.

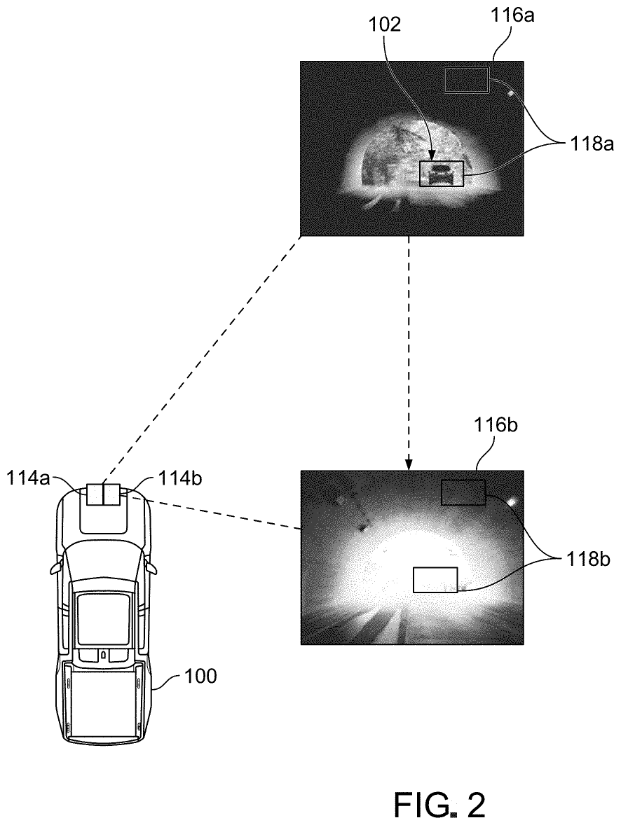

Turning now to FIG. 2, examples of image data 116a and 116b collected by the cameras 114a and 114b, respectively, as the vehicle 100 approaches the end of the intermediate region 112 of tunnel 106 (see FIG. 1) are illustrated and described in further detail. As noted above, ambient lighting may be increasing as the vehicle 100 nears the end of the tunnel 106. The camera 114b, relying upon an ambient light sensor, may take some small amount of time to react to the change in ambient lighting. As a result, areas 118b of the image 116b may be overexposed as a result of the exposure setting(s) of the camera 114b being adjusted for the darkened region 108 of the tunnel 106. The camera 114b may therefore take a relatively small amount of time to adjust exposure setting(s) in response to the increase in ambient light as the increase in ambient light occurs, during which the image data 116b collected by the camera 114b is overexposed. By contrast, the camera 114a may be adjusted in anticipation of the increase in ambient lighting. Accordingly, at the time the vehicle 100 reaches the location where ambient light begins to change, the areas 118a in the image data 116a collected by the camera 114a does not have the areas of overexposure typical of the image data 116b collected by the camera 114b. In some examples, one or more of the areas 118a of the image data 116a may be relatively underexposed, resulting in areas of darkness of the image data 116a, at least in relation to the image data 116b.

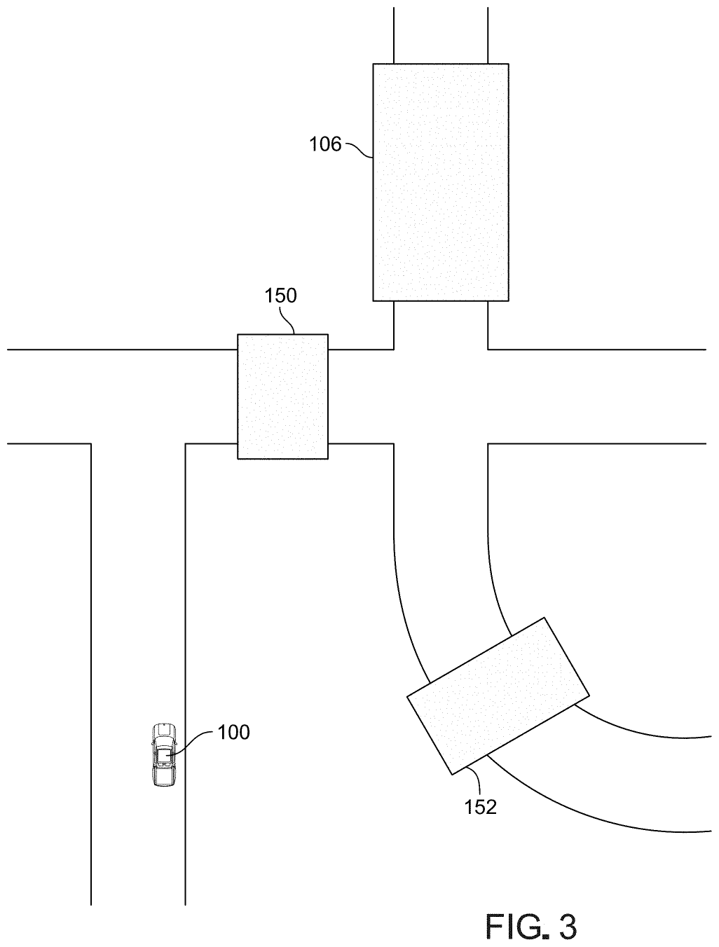

Referring now to FIG. 3, vehicle 100 is illustrated schematically on a map comprising different areas having ambient light changes. For example, the tunnel 106 is known to be a relatively dark region. An additional tunnel 150 and tollbooth 152, merely as examples, are each also known to have relatively darkened areas that may necessitate changes in camera exposure setting(s) as the vehicle 100 travels into/out of an ambient light transition. Additional ambient light transition locations associated with regions 106, 150, and 152 may each be known to vehicle 100 and/or may be stored at a memory or controller of the vehicle 100. In this manner, the vehicle 100 may generally determine a proximity of the vehicle 100 to ambient light transition locations associated with regions 106, 150, and/or 152.

Vehicle 100 may have a memory, database or the like that includes location data of ambient lighting changes, e.g., increases or decreases in ambient lighting associated with entering or exiting the tunnel 106. Accordingly, based upon a location, speed, or path of the vehicle 100, for example, the vehicle 100 may predict an upcoming transition in ambient light levels and adjust one or more settings of camera 114a before the expected transition occurs.

Methods of embodiments of the disclosure may be implemented in any system that allows cameras or other sensors to capture sufficiently accurate images of an area in front of the vehicle, e.g., to detect obstructions, objects, pedestrians, vehicles, or the like. As one example, vehicles such as autonomous vehicles may have cameras built thereinto or thereon, to capture images of nearby vehicles. Processing circuitry of the vehicle, or remote processing circuitry, may then implement the above-described adjustments to one or more exposure setting(s) of a camera. Vehicles may thus determine drivable and non-drivable spaces of their surroundings, e.g., to assist in applications such as autonomous navigation.

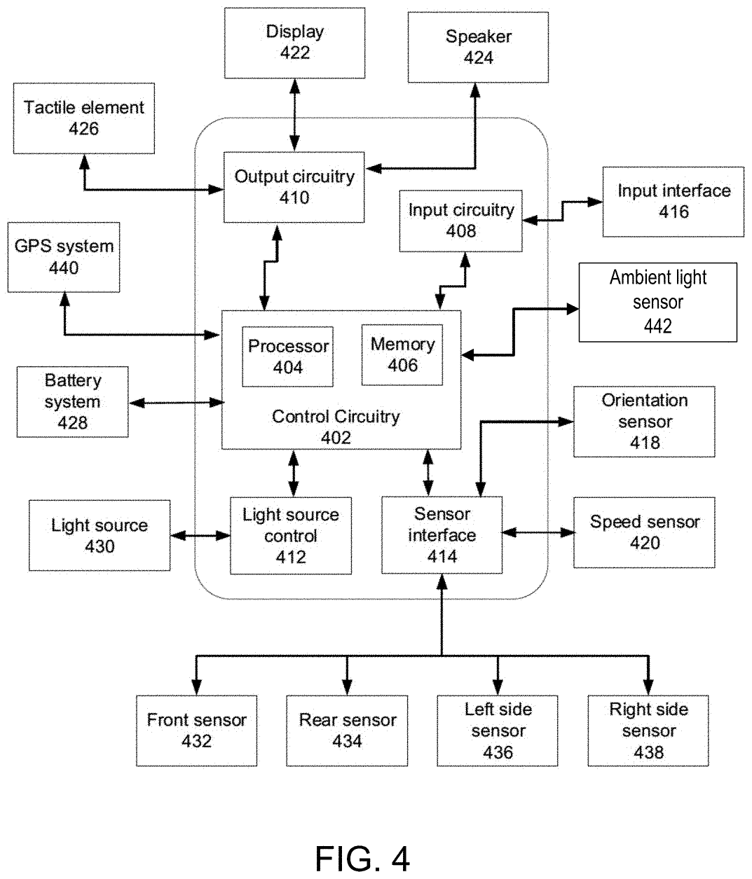

FIG. 4 shows a block diagram of components of a system of one such vehicle 400, in accordance with some embodiments of the present disclosure. Vehicle 400 may correspond to vehicle 100 of FIG. 1. Vehicle 400 may be a car (e.g., a coupe, a sedan, a truck, an SUV, a bus), a motorcycle, an aircraft (e.g., a drone), a watercraft (e.g., a boat), or any other type of vehicle.

Vehicle 400 may comprise control circuitry 402 which may comprise processor 404 and memory 406. Processor 404 may comprise a hardware processor, a software processor (e.g., a processor emulated using a virtual machine), or any combination thereof. In some embodiments, processor 404 and memory 406 in combination may be referred to as control circuitry 402 of vehicle 400. In some embodiments, processor 404 alone may be referred to as control circuitry 402 of vehicle 400. Memory 406 may comprise hardware elements for non-transitory storage of commands or instructions, that, when executed by processor 404, cause processor 404 to operate the vehicle 400 in accordance with embodiments described above and below. Control circuitry 402 may be communicatively connected to components of vehicle 400 via one or more wires, or via wireless connection.

Control circuitry 402 may be communicatively connected to input interface 416 (e.g., a steering wheel, a touch screen on display 424, buttons, knobs, a microphone or other audio capture device, etc.) via input circuitry 408. In some embodiments, a driver of vehicle 400 may be permitted to select certain settings in connection with the operation of vehicle 400 (e.g., color schemes of the urgency levels of FIG. 3, manners of presentation of the suggested steering indicator, when to provide the suggested steering indicator, etc.). In some embodiments, control circuitry 402 may be communicatively connected to GPS system 440 of vehicle 400, where the driver may interact with the GPS system via input interface 416. GPS system 440 may be in communication with multiple satellites, e.g., GPS satellites, GNSS satellites, or the like, to ascertain the driver's location and provide navigation directions to control circuitry 402.

Control circuitry 402 may be communicatively connected to display 422 and speaker 424 by way of output circuitry 410. Display 422 may be located at a dashboard of vehicle 400 (e.g., dashboard 204 and/or dashboard 208 of FIG. 2) and/or a heads-up display at a windshield (e.g., windshield 206 of FIG. 2) of vehicle 400. In some example, representations of image data 116a and/or 116b may be generated for display at display 422, and display 422 may comprise an LCD display, an OLED display, an LED display, or any other type of display that is convenient. Speaker 424 may be located at any location within the cabin of vehicle 400, e.g., at the dashboard of vehicle 400, on an interior portion of the vehicle door. Display 422 and speaker 424 may provide visual and audio feedback, respectively, in connection with providing a suggested steering action indicator to a driver of vehicle 400 to turn vehicle 400 towards a side to avoid an obstacle or non-drivable space.

Control circuitry 402 may be communicatively connected to tactile element 426 via output circuitry 410. Tactile element 426 may be a mechanical device, e.g., comprising actuators configured to vibrate to cause a tactile or haptic sensation of the body of the driver. The tactile element may be located at one or more of a variety of locations in vehicle 400 (e.g., on a driver's seat, a passenger seat, a steering wheel, brake pedals, and/or gas pedals) to provide haptic feedback in connection with providing a suggested steering action indicator to a driver of vehicle 400 to turn vehicle 400 towards the side to avoid an object, e.g., vehicle 102 of FIG. 1.

Control circuitry 402 may be communicatively connected (e.g., by way of sensor interface 414) to sensors (e.g., front sensor 432, rear sensor 434, left side sensor 436, right side sensor 438, orientation sensor 418, speed sensor 420). Orientation sensor 418 may be an inclinometer, an accelerometer, a tiltmeter, any other pitch sensor, or any combination thereof and may be configured to provide vehicle orientation values (e.g., vehicle's pitch and/or vehicle's roll) to control circuitry 402. Speed sensor 420 may be one of a speedometer, a GPS sensor, or the like, or any combination thereof, and may be configured to provide a reading of the vehicle's current speed to control circuitry 402.

In some embodiments, front sensor 432 may be positioned at a variety of locations of vehicle 400, and may be one or more of a variety of types, e.g., a camera, an image sensor, an infrared sensor, an ultrasonic sensor, a radar sensor, LED sensor, LIDAR sensor, etc., configured to capture an image or other position information of a nearby object such as a vehicle (e.g., by outputting a light or radio wave signal, and measuring a time for a return signal to be detected and/or an intensity of the returned signal, and/or performing image processing on images captured by the image sensor of the surrounding environment of vehicle 400). Further, in some examples the front sensor 432 may include multiple cameras, e.g., as with cameras 114a and 114b of vehicle 100 described above.

Control circuitry 402 may have locations of ambient light transitions stored, e.g., on memory 406. Control circuitry 402 may be configured to predict transitions of ambient light at vehicle 400, e.g., based upon location information provided by GPS system 440, known routes of the vehicle 400, and the locations of ambient light transitions.

Control circuitry 402 may be communicatively connected to battery system 428, which may be configured to provide power to one or more of the components of vehicle 400 during operation. In some embodiments, vehicle 400 may be an electric vehicle or a hybrid electric vehicle.

Control circuitry 402 may be communicatively connected to light source 430 via light source control 412. Light source 430 may be, e.g., a series of LEDs, and may be located at one or more of a variety of locations in vehicle 400 to provide visual feedback in connection with providing suggested steering action indicator to a driver of vehicle 400 to turn vehicle 400 towards a side to avoid the first obstacle.

It should be appreciated that FIG. 4 only shows some of the components of vehicle 400, and it will be understood that vehicle 400 also includes other elements commonly found in vehicles (e.g., electric vehicles), e.g., a motor, brakes, wheels, wheel controls, turn signals, windows, doors, etc.

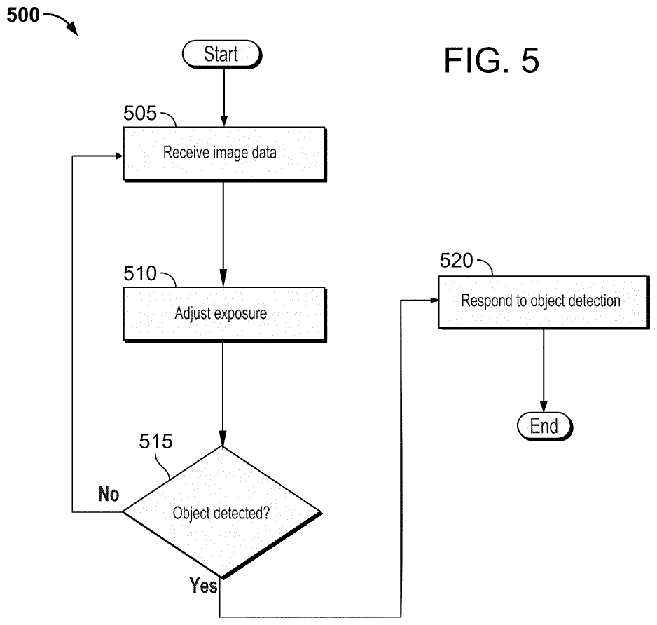

Turning now to FIG. 5, an example process of collecting image data from a vehicle is illustrated and described in further detail. The process 500 may be employed, for example, in the context of an autonomous or semi-autonomous vehicle, in which image data is collected and used to determine a presence of objects, obstructions, vehicles, pedestrians, or the like in/near a path of a vehicle. In another example, image data may be collected by a vehicle to provide warnings or notifications to a driver of the vehicle with respect to objects near/around a path of the vehicle.

Process 500 may begin at block 505, where image data is received from one or more cameras or sensors. For example, image data may be received from a forward-facing camera of a vehicle, e.g., cameras 114 of vehicle 100, and/or a front sensor 432 of vehicle 400. The camera may have an adjustable exposure or sensitivity to ambient light. Process 500 may then proceed to block 510.

At block 510, an exposure of a camera may be adjusted based upon an anticipated change in ambient light determined from a location of the camera. In some example approaches, adjustments to exposure setting(s) are made with the camera in a constant ambient light environment, or when ambient lighting is otherwise not changing to the extent of the anticipated change in ambient light. In some examples, a controller or vehicle may have various ambient light transition locations, e.g., stored at a memory. The vehicle may also use a location sensor to determine a location of the camera and/or the vehicle, e.g., by way of GPS or GNSS satellites, merely as examples. Accordingly, the controller/vehicle may determine whether/when the vehicle is approaching one of the ambient light transition locations.

The controller may, in response to the detection that the vehicle/camera is approaching an ambient light transition, proceed to adjust the camera exposure in advance of the vehicle reaching the location where the ambient light transition begins or is detectable by ambient light sensor(s) of the vehicle. A moving direction of the vehicle and/or a vehicle speed may, in some examples, also be utilized to determine timing for implementing a change to a camera setting or camera exposure. In some example illustrations, adjusting a camera exposure may include changing one or more of a camera aperture setting, a camera shutter speed setting, or a camera light sensitivity setting.

As noted above, some ambient light transition areas, e.g., tunnels, may negatively affect ability of a vehicle or controller thereof to use location data obtained via GPS system 440. In such examples, processing circuitry may be configured to determine the location of the vehicle 100 and/or 400 based upon a last known location, wheel speed of the vehicle, steer angle, or the like to determine a real-time location of the vehicle. The vehicle may thereby also determine whether/when ambient light transitions are being approached, e.g., toward the end of a tunnel 106, intermediate region 112, or the like.

Proceeding to block 515, process 500 may query whether an object is in a path of the vehicle, e.g., based upon image data collected by the vehicle via cameras 114, sensor(s) 432, or the like.

In some example approaches described above, a vehicle may have multiple cameras, e.g., cameras 114a and 114b of vehicle 100, with the cameras each configured to respond to ambient light changes differently. More particularly, as described above a first camera 114a may adjust one or more exposure settings in response to predicted changes in ambient lighting, such that setting(s) are adjusted in advance of the predicted/expected change in ambient lighting. By contrast, a second camera 114b may also adjust exposure settings or sensitivity to ambient light but may adjust exposure setting(s) based upon current/real-time ambient light levels, e.g., as determined by an ambient light sensor or the like. To the extent the image data sets 116a and 116b are each appropriate for their respective ambient light environments, a logic or heuristic for detecting objects, vehicles, or the like may determine a presence of an object when either of the image data sets 116 are illustrative of the object. Accordingly, in an example where the vehicle is approaching an ambient light transition and exposure setting(s) of the camera 114a are less appropriate for the ambient light levels at that moment (i.e., the ambient light level has not yet changed to the predicted level for which the exposure setting(s) of the camera 114a are adapted), the vehicle may rely upon the image data set 116b of the other camera 114b. Subsequently, when the ambient lighting levels being to shift, the vehicle may rely upon the image data set 116a of the camera 114a, as the camera 114a is adapted to the different ambient lighting levels.

Where process 500 determines a presence of an object in the path of the vehicle 100, process 500 may proceed to block 520 where the vehicle may initiate a response to the detection of the object/vehicle. To the extent the vehicle is operating in a semi-autonomous or fully autonomous mode, the vehicle may initiate a lane change or turn, slow down, or the like. To any extent a driver of the vehicle retains control of the vehicle, process 500 may generate a warning or notification of the detected object. Where process 500 does not detect an object at block 515, process 500 may proceed to block 505, where additional image data is collected.

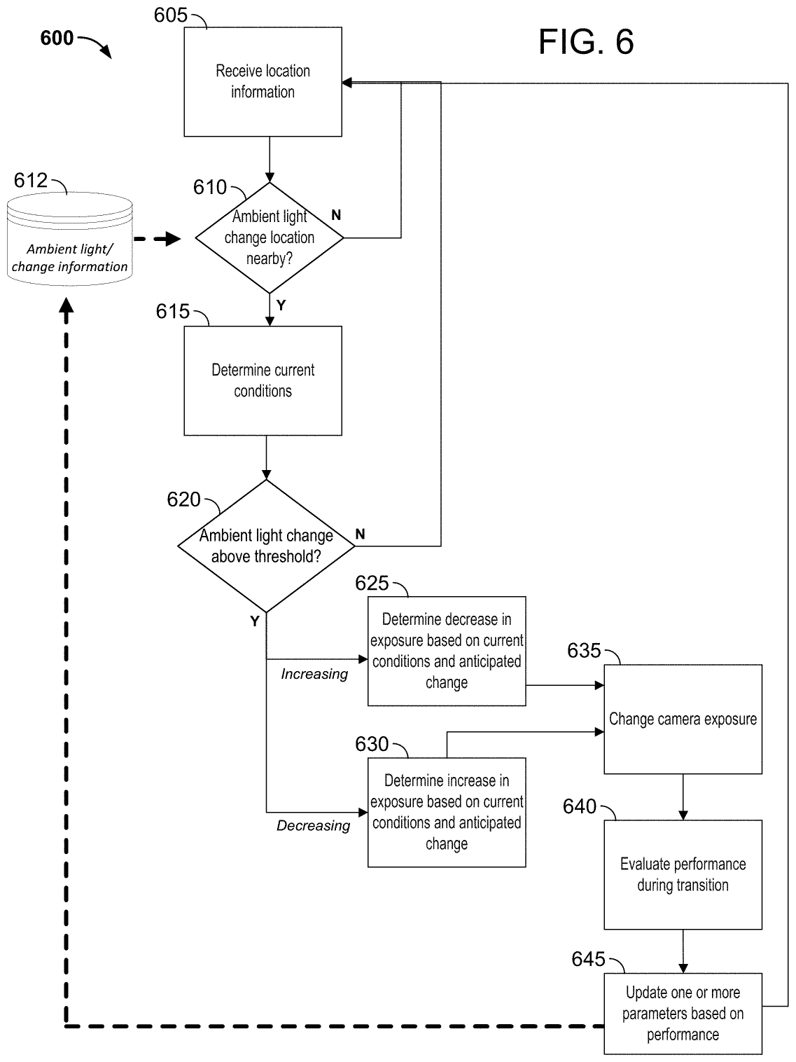

Referring now to FIG. 6, an example process 600 of adjusting a camera setting is illustrated and described in further detail. Process 600 may be employed, for example, in the context of an autonomous or semi-autonomous vehicle, and/or a vehicle configured to provide warnings or notifications to a driver of the vehicle with respect to objects near/around a path of the vehicle. For example, process 600 may be embodied in vehicle 100, vehicle 400, and/or components thereof such as controllers, processors, memories, or the like.

Process 600 may begin at block 605, where location information is received. For example, a location of a vehicle 100/400, camera 114 or other sensor may be determined, e.g., by a controller or processor associated with a central gateway module (CGM) or one or more electronic control units (ECUs) of the vehicle.

Proceeding to block 610, process 600 may query whether that an ambient light change location is nearby or that the camera/vehicle will pass through the ambient light change location. For example, if vehicle 100 is driving on a route that passes through an ambient light change location, e.g., a tunnel 106, process 610 may determine that the camera will pass through the ambient light change location and proceed to block 615, e.g., based upon the direction and/or speed of travel of the vehicle. Process 600 may also receive information from a database 612 of ambient light change information, which may include locations of various ambient light change locations that are known. As will be discussed further below, parameters relevant to adjustment of camera exposure, extent of ambient light changes, or other information may also be stored in the database 612. Process 600 may also analyze vehicle speed information in addition to any known location information of the camera/vehicle, e.g., to determine whether/when the camera/vehicle may arrive at the ambient light change location.

If process 600 determines that the vehicle/camera is not currently expected to pass through an ambient light change location, and/or that an ambient light change location is not otherwise nearby, process 600 may proceed back to block 605. Process 600 may thereby receive updated location information of the vehicle/camera to determine whether/when an ambient light change location may be approached by the vehicle/camera.

Proceeding to block 615, process 600 may determine current conditions of the vehicle/camera with respect to ambient light conditions. For example, process 600 may determine ambient light levels or other characteristics known to affect ambient light, e.g., a time of day relative to sunrise/sunset, weather conditions (e.g., full sun, cloudy, etc.), or any other factors that may affect ambient light conditions. Process 600 may then proceed to block 620.

At block 620, process 600 may query whether an ambient light change above a threshold level is anticipated based upon the current conditions and any characteristics of the ambient light change location. For example, if conditions are sunny and the vehicle is about to enter a relatively dark tunnel, the difference in ambient light conditions of the two environments may exceed a threshold difference, and it may be desired to advance exposure adjustments of one or more cameras by proceeding to blocks 625 or 630 as described below. Alternatively, if a threshold difference is not reached, e.g., conditions are relatively dark and similar to conditions inside a tunnel into which the vehicle is expected to enter, advance adjustment of exposure setting(s) of the camera may not be necessary, and process 600 may proceed back to block 605.

Where process 600 answers the query of block 620 affirmatively, process 600 may proceed to blocks 625 or 630 depending on the nature of the expected change in ambient light, e.g., as determined in a comparison of current conditions and ambient light at an ambient light change location. More particularly, if the anticipated ambient light change will increase ambient light intensity/levels, at block 625 process 600 may determine a decrease in exposure based upon the current conditions and the anticipated change. Alternatively, if the anticipated ambient light change will decrease ambient light intensity/levels, at block 630 process 600 may determine an increase in exposure based upon the current conditions and the anticipated change.

Proceeding to block 625, process 600 may implement a change in camera exposure, e.g., via one or more camera settings relevant to ambient light sensitivity. For example, process 600 may implement changes in a setting of camera 114 such as an aperture setting, shutter speed, ISO setting, or the like. In some example approaches, a setting may be changes to affect how an exposure is determined such that it will result in a desired decrease/increase in exposure. For example, a location within image data 116 where the camera 114 is balancing for brightness may be shifted to create the desired change in exposure. More specifically, a center region of image data 116 may be the basis of exposure adjustments when approaching/leaving tunnel 106, thereby enabling a quicker reaction to changes in ambient light due to the focus on more distance areas within the image data 116 (i.e., the exposure is adjusted based upon image data “further down the road from the vehicle/camera). The change in exposure may, in some examples, be temporary, such that exposure settings are returned to automatically respond to current ambient lighting levels after the vehicle/camera passes through the ambient light change location(s). Accordingly, process 600 may facilitate changing exposure of a camera in advance of an anticipated change in ambient light, and subsequently returning the camera to “normal” ambient light exposure adjustments.

Proceeding to block 640 process 600 may evaluate performance of the camera and/or vehicle during a transition of the camera or vehicle through the ambient light change location(s). For example, image data from two cameras 114a, 114b may be reviewed by process 600 to determine whether the advanced change in exposure settings was sufficient or insufficient, etc. Accordingly, process may at block 645 update one or more parameters based on performance as evaluated at block 640. The parameters, locations, or other data may be provided to database 612, thereby generally updating parameters, locations, and other data relating to ambient light change locations or conditions. In some examples, an HD map may be adjusted, e.g., to change locations of ambient light change locations, or to reflect more/less significant ambient light changes than initially expected, or the like.

Process 600 may then proceed back to block 605. Accordingly, the process 600 generally continues reviewing location information to determine whether/when a camera or vehicle may encounter anticipated ambient light change locations.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A vehicle system, comprising:
a camera configured to collect image data; and
a controller in communication with the camera, wherein the controller is configured to determine an anticipated change in ambient light based on a location of the camera and a moving direction of the vehicle, wherein the controller is configured to adjust an exposure of the camera based on the anticipated change in ambient light.

2. The vehicle system of claim 1, wherein the camera is a forward-facing camera of the vehicle.

3. The vehicle system of claim 2, further comprising an additional forward-facing camera of the vehicle, wherein a camera exposure of the additional forward-facing camera is not adjusted based on the anticipated change in ambient light, wherein the controller is configured to determine a presence of an object in front of the vehicle when either of the forward-facing cameras detect the object.

4. The vehicle system of claim 1, wherein the controller is configured to adjust the camera exposure in response to a detection of the vehicle approaching an ambient light transition location.

5. The vehicle system of claim 1, wherein the controller is in communication with a memory comprising a plurality of ambient light transition locations.

6. The vehicle system of claim 1, further comprising a location sensor in communication with the controller, the location sensor configured to determine the location of the camera.

7. The vehicle system of claim 1, wherein the controller is configured to determine the location of the camera from one of a global positioning satellite (GPS) sensor or a global navigation satellite system (GNSS) sensor.

8. The vehicle system of claim 1, wherein the controller is configured to determine the location of the camera based upon a vehicle speed.

9. The vehicle system of claim 1, wherein the controller is configured to adjust the camera exposure by adjusting one or more of a camera aperture setting, a camera shutter speed setting, or a camera light sensitivity setting.

10. An autonomous driving system for a vehicle, comprising:
a forward-facing camera configured to collect image data for autonomous vehicle guidance;
a controller in communication with the camera, wherein the controller is configured to determine an anticipated change in ambient light based on a detection of the vehicle approaching an ambient light transition location, wherein the controller is configured to adjust an exposure of the camera based on the anticipated change in ambient light;
an additional forward-facing camera of the vehicle, wherein the controller is configured to adjust exposure of the additional forward-facing camera in response to changes in ambient light received at the additional forward-facing camera;
wherein the controller is configured to determine a presence of an object when either of the forward-facing cameras detect the object.

11. A method of adjusting a camera setting, comprising:
determining an anticipated change in ambient light based on a location of a camera and a moving direction of a vehicle; and
adjusting an exposure of the camera based on the anticipated change in the ambient light.

12. The method of claim 11, wherein the camera is a forward-facing camera of the vehicle.

13. The method of claim 12, further comprising adjusting exposure of an additional forward-facing camera in response to changes in ambient light received at the additional forward-facing camera.

14. The method of claim 12, further comprising determining a presence of an object in front of the vehicle when either of the forward-facing cameras detect the object.

15. The method of claim 11, further comprising adjusting the camera exposure in response to a detection of the vehicle approaching an ambient light transition location.

16. The method of claim 11, further comprising storing a plurality of ambient light transition locations in a memory installed in the vehicle.

17. The method of claim 11, wherein the location of the camera is determined by a location sensor.

18. The method of claim 17, wherein the location sensor includes one of a global positioning satellite (GPS) sensor or a global navigation satellite system (GNSS) sensor.

19. The method of claim 11, further comprising determining the location of the camera based upon a vehicle speed.

20. The method of claim 11, wherein adjusting the camera exposure includes adjusting one or more of a camera aperture setting, a camera shutter speed setting, or a camera light sensitivity setting.
